(19) United States
(12) Patent Application Publication
(10) Pub. No.: US 2008/0000652 A1
(43) Pub. Date: Jan. 3, 2008

(54) Towable backhoe

(76) Inventor: William C. Johnson, Leawood, KS (US)

Correspondence Address: LAW OFFICE OF JOHN C. MCMAHON, P.O. BOX 30069, KANSAS CITY, MO, 64112, US

(21) Appl. No.: 11/804,206

(22) Filed: May 17, 2007

Related U.S. Application Data
(60) Provisional application No. 60/800,995, filed on May 17, 2006.

(51) Int. Cl. A01B 35/32

(52) U.S. Cl. 172/71; 172/114; 172/679

(57) ABSTRACT

A towable backhoe having a frame with a pair of hydraulically indirectly operated front wheels and a pair of rear wheels. The front wheels include lock out hubs. The rear wheels can be configured between a lowered work configuration and a raised towing configuration. The backhoe includes a rear hitch for connecting to a towing vehicle in the towing configuration.

### CROSS REFERENCE TO RELATED APPLICATIONS

This application claims the benefit of U.S. Provisional Application No. 60/800,995 filed May 17, 2006.

### BACKGROUND OF THE INVENTION

The present application is directed to earth moving equipment, especially hydraulically driven backhoes, that are towable to a job site and, thereafter, convertible to a hydraulically driven and self propelled vehicle.

In the field of construction equipment, various equipment for earth moving are often either track mounted type vehicles or hydraulically driven wheeled vehicles that are not suitable for driving directly over roads, in the case of the track driven equipment because they tear up the roadway and are not designed for high speeds and in the case of the hydraulic driven equipment because they are not designed to drive at higher speeds. Consequently, such equipment is often carried to a job site on a trailer or the like. This increases the cost of the equipment in that a trailer is always required. The need for a trailer complicates transfer to the job site and the trailer requires a separate towing vehicle.

Another problem with such devices is that when hydraulic drives are utilized, the hydraulic system does not lend itself to be towed and the hydraulic units with transmissions are relatively very expensive. Therefore, it is desirable to have a backhoe or other earth working equipment that can be easily towed at highway speeds by another vehicle, such as a pickup truck, and that can be operated at a job site by hydraulic systems that are easy to use and relatively inexpensive.

### SUMMARY OF THE INVENTION

An earth working device, especially a backhoe, includes a frame, a motor and an articulated arm with a scoop or bucket for digging in the ground. The earth working device is self-propelled at the work site and has at least two wheels that are driven by hydraulic drives. Preferably, the drive wheels are located at the same or front end as the articulated arm and bucket.

The device is convertible between a work configuration wherein the device is self propelled with all wheels on the ground and wherein at least two of the wheels are driven by hydraulic motors to a towing configuration wherein only one set of wheels is ground engaging and the hydraulic system associated with the drive wheels is disabled so that the drive wheels are free turning. The non driven set of wheels are swingable or moveable between direct ground engagement in the work configuration to a raised position in the towing configuration. A tongue allows the device to be joined to a conventional ball type hitch on the rear of a towing vehicle, such as a pickup truck.

The hydraulic motor that powers the drive wheels is operated by a seated operator through a hydraulic control system by levers and is driven by a hydraulic pump operated by a gasoline driven motor. Output from each hydraulic motor is not directly transferred to the drive wheels, but rather is transferred by a drive chain to a respective wheel shaft that is joined to a wheel. Each wheel includes a lockout hub that allows an operator to selectively engage the wheels with the drive shaft or to disengage the wheels, leaving them freely rotating, for towing. Each motor is non axially aligned with a respective drive shaft and a gear reduction mechanism is included between the motor output and a respective wheel drive shaft.

### OBJECTS OF THE INVENTION

Therefore, the objects of the invention are: to provide an inexpensive backhoe that can be hydraulically self driven at a job site, but which can also be easily towed between job sites by a towing vehicle without requiring a trailer for the backhoe; to provide such a backhoe that includes a hydraulic motor for each drive wheel which is axially offset from the support shaft for the drive wheel; to provide such a backhoe wherein the drive wheels include lock outs that allow an operator to selectively connect with the drive wheels to associated hydraulic motors when in a job site or work configuration or to disconnect from the motors and freewheel when in a transit or towing configuration; to provide such a backhoe having rear wheels that can be taken out of contact with the road when in the transit or towing configuration and especially can be raised relative to a frame of the backhoe; and to provide such a backhoe which is easy to use, inexpensive to produce and especially suited for the intended usage thereof.

Other objects and advantages of this invention will become apparent from the following description taken in conjunction with the accompanying drawings wherein are set forth, by way of illustration and example, certain embodiments of this invention.

The drawings constitute a part of this specification and include exemplary embodiments of the present invention and illustrate various objects and features thereof.

### BRIEF DESCRIPTION OF THE DRAWINGS

FIG. 1 is a perspective view of a backhoe in accordance with the present invention shown in a work configuration at a job site.

FIG. 2 is a side elevational view of the backhoe in a towing configuration and a partial view of a towing vehicle.

FIG. 3 is a fragmentary front elevational view of the backhoe showing a rear wheel in the work configuration.

FIG. 4 is a fragmentary front elevational view of the backhoe showing the rear wheel in the towing configuration.

FIG. 5 is a fragmentary rear elevational view of the backhoe showing a front wheel mounting and drive assembly.

FIG. 6 is a cross sectional view, generally taken along line 6-6 of FIG. 5, showing the front wheel mounting and drive assembly and showing a front axle in phantom.

### DETAILED DESCRIPTION OF THE ILLUSTRATED EMBODIMENT

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

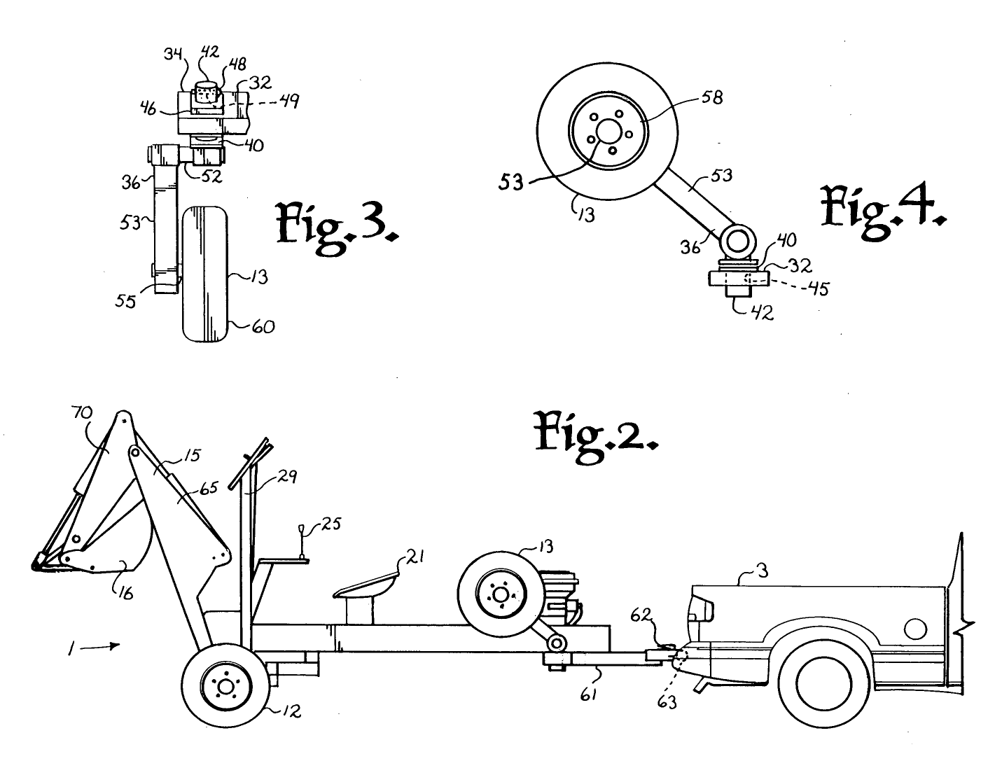

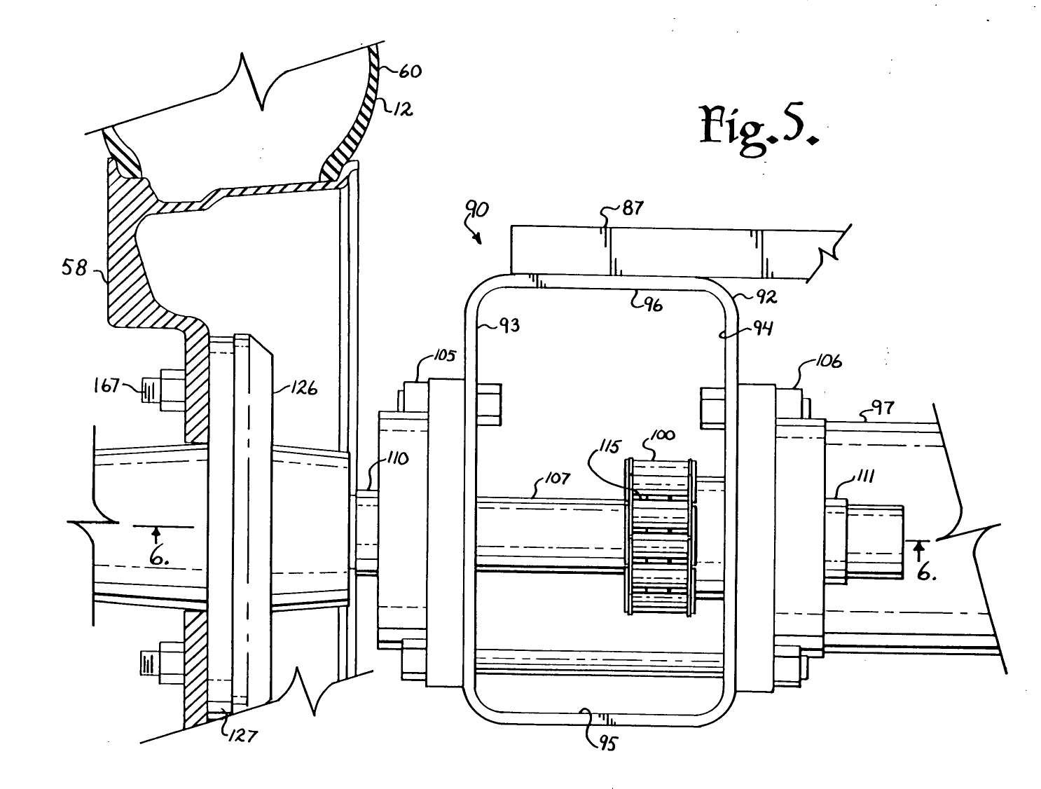

The reference numeral 1 generally designates a towable and hydraulically driven backhoe in accordance with the present invention. The backhoe 1 is shown in FIG. 2 being towed by a towing vehicle or truck 3.

The backhoe 1 includes a frame 10 supported on a pair of front wheels 12 and a pair of rear wheels 13. Attached to the frame 10 is a hydraulically operated articulated arm 15 terminating in a digging bucket or scoop 16. Mounted on the frame 10 is an engine 20 and a seat 21 for supporting a driver 23 at a hand operated hydraulic control system 25. The frame 10 also supports a pair of positional stabilizing legs 29 and 30.

The frame 10 is elongate between the wheel pairs 12 and 13 and is designed to be simple, but effective, in order to reduce cost. The frame 10 is a tubular structure constructed of metal.

A cross beam 32 is mounted near the rear of the frame 10 on the underside thereof. The cross beam 32 extends laterally outward on either side of the frame 10 and operably functions to support the pair of rear wheels 13 with one of the rear wheels 13 being mounted near a respective outer end 34 thereof by a rear wheel mounting structure 36, best seen in FIG. 3.

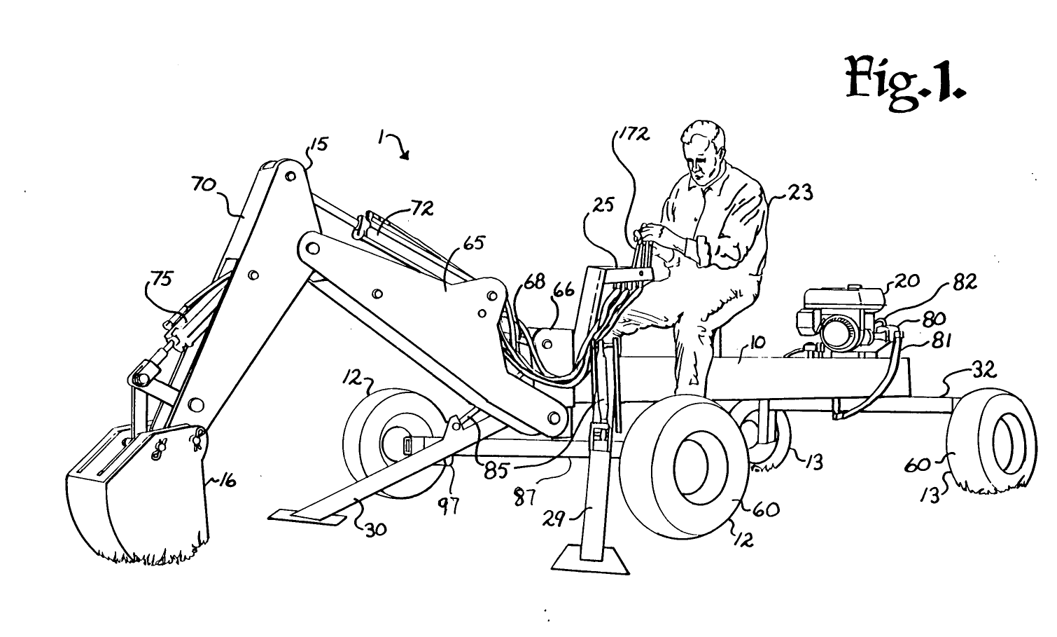

Each rear wheel mounting structure 36 includes a connecting member 40 that has a distal end terminating in a cylinder or pivot 42. The pivot 42 is sized and shaped to be snugly but pivotally received in and pass through a receiving bore 45 in the cross beam 32. A sleeve 46 is received over the pivot 42 above the cross beam 32, when the backhoe 1 is configured for digging as in FIGS. 1 and 3. A keeper pin 48 is received through an aperture 49 in the pivot 42 to secure the cylinder 42 in the bore 45 during use.

The mounting structure 36 further includes a cross arm 52 extending from the connecting device 40 which is in turn connected to a depending armor strut 53. The strut 53 has a horizontally aligned axle 55 upon which a hub 58 of a respective rear wheel 13 is mounted. To convert to a transport configuration, such as is seen in FIG. 2, the keeper pin 48 is removed and the mounting structure 36, along with an associated wheel 13 is removed from the cross beam 32 by sliding downwardly (which may require lifting the rear of the backhoe 1), rotated one hundred and eighty degrees and then the pivot 42 is replaced in the bore 45 and secured therein in reverse to the normal operating configuration by replacing the keeper pin 48. In this manner, the rear wheels 13 project above the frame 10 in the transport configuration so as to be stowed for transport.

The front wheels 12 and the rear wheels 13 each include a rubber ground engaging tire 60. The tires 60 of the front wheels 12 are suitable for supporting the backhoe 1 during transit while being pulled by the vehicle 3 on a road or highway at normal driving speeds for public roads and the like.

Projecting from the rear of the frame 10 is a towing tongue 61 having a conventional towing hitch 62 thereon adapted to mate with a towing ball 63 mounted on the towing vehicle 3.

The articulated arm 15 has a first segment 65 pivotally mounted on a front mount 66 of the frame 10. The angle of the first segment 65 relative to the ground is controlled by a first hydraulic cylinder 68 that is mounted between the first segment 65 and the front mount 66. The arm 15 also has a second segment 70 that is pivotally mounted at respective ends thereof to a distal end of the first segment 65 and the scoop 16. A second hydraulic cylinder 72 mounted between the first segment 65 and the second segment 70 controls the position of the later with respect to the first segment 65. A third hydraulically controlled cylinder 75 is connected between the second segment 70 and the scoop 16 so as to control the position of the scoop 16 relative to the second segment 70.

The illustrated engine 20 is an internal combination engine mounted directly on the frame 10, although it is foreseen that a wide variety of motive devices could be used to power the backhoe 1. Associated with the engine 20 is a hydraulic pump 80 that is joined to the control manifold 25 by hydraulic supply hose 81 and is connected to a hydraulic fluid return hose 82. Each of the stabilizing legs 29 and 30 is pivotally mounted on the frame 10 and each is controlled by a respective hydraulically operated cylinder 85. Hydraulic systems of this type are well known in the hydraulic art and further description thereof is not required herein to allow one having ordinary skill in the art to make use of this part of the invention.

A front generally transverse extending axle 87 is pivotally mounted to the front end frame 10 and is connected near opposite ends thereof to the front wheels 12. Each of the front wheels 12 is connected to the axle 87 and supported and operably driven or rotated by a wheel mounting assembly 90.

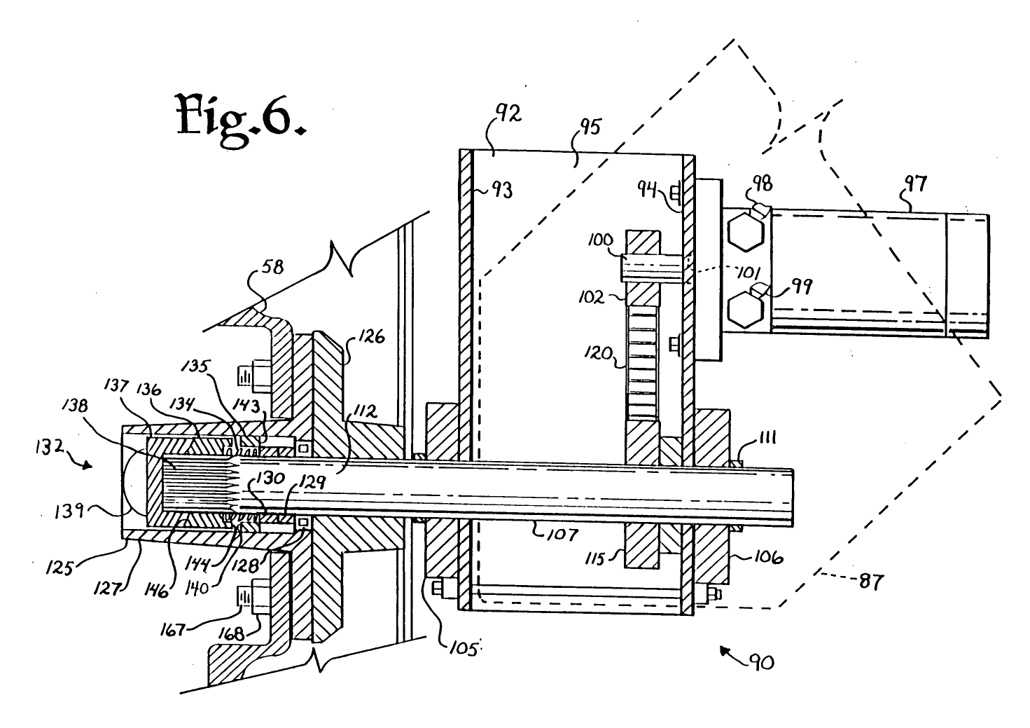

One of the front wheel mounting assemblies 90 is illustrated in FIGS. 5 and 6. Each assembly 90 includes a generally rectangularly shaped rigid channel 92 which is fixedly attached by welding or the like to the underside of a respective end of the front axle 87. Each channel 92 has open ends and side walls 93 and 94 joined by a bottom wall 95 and a top wall 96.

Mounted on the side wall 94 is a hydraulic motor 97 having a feed hydraulic line 98 and a return hydraulic line 99. The hydraulic lines 98 and 99 are respectively connected to the supply hose 80 and return hose 81 through which flow of hydraulic fluid is controlled by the operator control system 25 which functions conventionally.

Each motor 97 has a drive shaft 100 that is mounted in an opening 101 in the side wall 94 so as to extend into the interior of a respective channel 92. Mounted on each drive shaft 100 is a drive sprocket gear 102.

Mounted on opposite side walls 93 and 94 are a pair of axially aligned bearing blocks 105 and 106 respectively which pivotally receive a wheel support shaft 107 therein. The shaft 107 is maintained in the blocks 105 and 106 by keepers 110 and 111 and has a wheel receiving portion 112 that projects outwardly from the channel 92 and away from the frame 10. Fixedly secured to and mounted on the wheel support shaft 107 is a drive sprocket gear 115 which is aligned with the sprocket gear 102 and connected therewith by a drive chain 120. The sprocket gear 115 is somewhat larger in diameter than the sprocket gear 102 effectively providing a gear reduction therebetween. The drive shaft 100 is axially offset from and does not directly rotate the shaft 107.

Attached to the shaft wheel receiving portion 112 is a wheel lock out assembly 125. Each assembly 125 has a first sleeve 126 and an adjacent or abutting second sleeve 127. The first sleeve 126 is fixedly secured to and extends radially outward from the shaft 107. The second sleeve 127 is secured to the shaft 107 so as to be rotatable with respect to the shaft 107 and, in particularly, is mounted on bearing 128 which is held abuttingly against the sleeve 126 by two screwed on locking rings 129 and 130. The second sleeve 127 includes a lock out mechanism 132 that operably locks the second sleeve 127 to the rotation of the shaft 107 when configured to lock and allows the sleeve 127 to freely rotate or freewheel on the shaft 107 when in an unlocked configuration. In particular, each mechanism 132 includes a spring 134, a first ring 135, a second ring 136 and an end hub 137. The first ring 135 includes spline following engagement structure on a radially outward surface thereof. The outer side face of the ring 135 has an engagement surface 140 with teeth thereon. Located in the sleeve 127 and adjoining the ring 135 is a pattern of axially aligned spline like grooves into which the first ring 135 slides axially. The second ring 136 is mounted on axial splines 138 around the shaft 107 so that the second ring 136 rotates with the shaft 107 and the first ring 135 rotates with the sleeve 127. The second ring 136 also has an engagement mating structure 144 with teeth on the inner face thereof that align with engagement structure 140 on the first ring 135. The second ring 136 is moveable along the shaft 107 so that it can interferingly lock with the ring 135 when abutting together or not when separated. A spring 134 normally pushes the second ring 136 away from the first ring 135. However, the hub 137 is rotatable by a human using grip 139 and includes a cam 146 in the end of the hub 137 that allows an operator to overcome the spring 134, so as to lock the assembly 125 in a locked configuration or by reversing the process to allow unlock the sleeve 127 relative to the shaft 107, so that the sleeve 127 freely rotates relative to the shaft 107 in the unlocked configuration. Many types of prior art lock out devices have been produced for vehicles such as trucks with alternative four wheel drive and are available for this purpose. It is foreseen that many of these types of devices could be used for the lock out assembly described herein.

Each front wheel 12 has a road engaging tire 60 mounted on a wheel rim 58. The wheel rim 58 in turn mounts about the sleeve 127 and is secured thereto by studs 167 and nuts 168.

The hydraulic control manifold 25 provides the operator 23 with a plurality of control levers 172 for selectively allowing hydraulic fluid under pressure produced by the hydraulic pump 80 to control the three articulated arm cylinders 68, 72 and 75, the stabilizing leg control cylinders 85 and the wheel drive motors 97.

In use, the rear wheels 13 are configured as shown in FIG. 1 and the stabilizing legs 29 and 30 are positioned to allow movement when raised and stabilize when lowered against the ground. The articulating arm 15 is operated to maneuver the scoop 16 as needed. When it is desired to move at the job site, the wheel lock out assemblies 125 are locked, so that the front wheels 12 must rotate with the shaft 107 and the hydraulic motors 97 are then individually activated as needed to move the backhoe 1 to a new location by selectively rotating the front wheels 12.

When it is desired to move the backhoe 1 between job sites, the rear wheels 13 are removed from the crossbeam 32 rotated one hundred and eighty degrees and replaced so that respective pivots 42 are upside down in the bores 45 and the keeper pins 48 are used to secure them there. The wheel lock out assemblies 125 are manipulated to the unlocked configuration to allow the front wheels 12 to freewheel or rotate relative to the shaft 107. The hitch 62 is joined to the towing ball 63 on the towing vehicle 3, as shown in FIG. 2 and the backhoe 1 is then pulled on conventional roads and highways by the vehicle 3 to a new job site.

It is to be understood that while certain forms of the present invention have been illustrated and described herein, it is not to be limited to the specific forms or arrangement of parts described and shown.

What is claimed and desired to be secured by Letters Patent is as follows:

1. A towable hydraulically driven backhoe comprising:
a) a frame having an articulated arm mounted thereon;
b) a pair of rear wheels connected to said frame;
said rear wheels including mounting structure to allow said rear wheels to be moved between a work configuration wherein the rear wheels engage the ground and a towing configuration wherein the rear wheels are raised relative to said frame and not engaging the ground;
c) a pair of front wheels that are each connected to said frame and operably offset driven by a hydraulic motor;
d) for each front wheel a lockout hub to allow a user to select between a locked configuration and an unlocked configuration; and
e) a hitch located near a rear of the backhoe for towing said backhoe in said towing configuration.

2. The backhoe according to claim 1 wherein:
a) each of said rear wheels is mounted to said frame by an arm that includes a pivot that is removably positioned in said frame and said rear wheels depend from said frame in the work configuration and said rear wheels can be selectively inverted by removal, inversion and replacement of said pivot into said frame, so that each rear wheel extends above the frame in said towing configuration.

3. The backhoe according to claim 1 wherein:
a) each of said front wheel motors are mounted on a wheel mount connected to said frame and include a first sprocket that is rotated thereby;
b) each of said front wheels is axially mounted on a shaft;
c) a second sprocket is axially mounted on said shaft; and
d) said first and second sprockets are joined by a drive chain.

4. The backhoe according to claim 3 wherein:
a) said second sprocket is larger than said first sprocket.

5. In a towable backhoe having a front pairs of wheels, at least one rear wheel and a rear tongue for towing; the improvement comprising wherein:
a) said rear wheel is mounted by structure that allows repositioning of said rear wheel between a selectable first work configuration wherein said rear wheel depends from a frame of said backhoe and a second towing configuration wherein said rear wheel is positioned at least partly above said frame.

6. The backhoe according to claim 5 wherein:
a) said frame includes a rear lateral crossbeam with said rear wheel being a first rear wheel mounted on one side of said crossbeam and a second rear wheel mounted on an opposite side of said crossbeam; and
b) each of said rear wheels are connected to said crossbeam by an arm terminating in a pivot; said arm being having a first working position and being removable from said crossbeam and reversible to a second towing position so that at least a portion of said arm is selectively moveable between projecting downwardly and upwardly relative to said crossbeam in said respective positions.

7. In a towable backhoe that has front wheels that are hydraulically driven; the improvement comprising:
a) each of said front wheels includes a drive transfer structures that non axially transfers rotational drive from a respective motor to a front wheel.

8. The backhoe according to claim 7 wherein:
a) said drive transfer structure includes a first sprocket gear axially aligned with each motor and a second sprocket gear axially aligned with a drive shaft for a respective wheel; and wherein:
b) said first and second sprocket gears are joined by a drive chain.

9. The backhoe according to claim 8 wherein:
a) each of said wheels includes a lockout hub to allow for selective switching between said wheel operably rotating with said shaft and said wheel freewheeling with respect to said shaft.
